(19) United States
(12) Patent Application Publication
(10) Pub. No.: US 2025/0164149 A1
(43) Pub. Date: May 22, 2025

(54) Tank Water Heaters with Phase Change Material

(71) Applicant: Rheem Manufacturing Company, Atlanta, GA (US)

(72) Inventors: Saman Beyhaghi, Opelika, AL (US); Troy Edward Trant, Montgomery, AL (US); Shubham Srivastava, Suwanee, GA (US); Atilhan Manay, Roswell, GA (US)

(21) Appl. No.: 18/943,063

(22) Filed: Nov. 11, 2024

Related U.S. Application Data
(60) Provisional application No. 63/601,450, filed on Nov. 21, 2023.

(51) Int. Cl. F24H 7/00

(52) U.S. Cl. CPC F24H 7/002

(57) ABSTRACT

A water heater including a storage tank and an energy source is disclosed. The storage tank may be configured to store water. The storage tank comprises a top portion and a bottom portion. The bottom portion includes an enclosure configured to store a phase changing material (PCM). The energy source may be configured to heat the PCM to a predefined temperature via a heating source disposed in the enclosure. The PCM may be configured to transfer heat to the water stored in the storage tank when a temperature of water stored in the storage tank drops below the predefined temperature.

### CROSS-REFERENCE TO RELATED APPLICATIONS

The present application claims priority to and the benefit of U.S. provisional application No. 63/601,450, filed Nov. 21, 2023, which is hereby incorporated by reference herein in its entirety.

### FIELD

The present disclosure relates to tank water heaters and more specifically to tank water heaters using phase change material to improve water heater efficiency and First Hour Rating (FHR).

### BACKGROUND

Tank water heaters are generally used to provide a supply of heated water in a variety of applications, including residential, commercial, and industrial applications. A conventional tank water heater uses one or more heating sources, e.g., gas burner, electrical heating element, heat pump, etc. to heat water stored in a storage tank of the water heater. A tank water heater is typically equipped with a thermostat that regulates temperature of water stored in the storage tank. For example, the thermostat may activate the heating source to heat the water stored in the storage tank when the thermostat detects a drop in water temperature, e.g., when a user draws hot water from the water heater.

Frequent drops in water temperature may result in frequent activation of the heating source(s), thus resulting in loss of water heater efficiency. Further, even with frequent heating source activation and regulation of water temperature by the thermostat, there may be instances where the user may desire a greater supply of hot water or a higher First Hour Rating (FHR) of the water heater. A conventional water heater may not be able to meet higher demand of hot water from the user.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an exemplary water heater in accordance with one or more embodiments of the present disclosure.

FIG. 2 depicts a cross-sectional view of a storage tank of a water heater in accordance with one or more embodiments of the present disclosure.

FIG. 3 depicts a graph illustrating a change of temperature over time in a storage tank in accordance with one or more embodiments of the present disclosure.

FIG. 4 depicts a cross-sectional view of an exemplary storage tank in accordance with one or more embodiments of the present disclosure.

FIG. 5 depicts a cross-sectional view of an exemplary storage tank in accordance with one or more embodiments of the present disclosure.

FIG. 6 depicts a graph illustrating a change in tank outlet temperature over time in accordance with one or more embodiments of the present disclosure.

FIG. 7 depicts a flow diagram of an exemplary method to provide a water heater with a Phase Change Material (PCM) in accordance with one or more embodiments of the present disclosure.

FIG. 8 depicts a flow diagram of an exemplary method to provide a water heater with a PCM in accordance with one or more embodiments of the present disclosure.

FIG. 9 depicts a flow diagram of an exemplary method to provide a water heater with a PCM in accordance with one or more embodiments of the present disclosure.

### DETAILED DESCRIPTION

The present disclosure is directed towards a tank type water heater having a storage tank and a Phase Change Material (PCM) disposed in the storage tank or on an exterior surface of the storage tank. The storage tank may receive a supply cold water and may store the received water therein. The water heater may further include a heating source that may heat the water stored in the storage tank to a predefined temperature (e.g., a desired water temperature) when a temperature of water in the storage tank drops below a threshold temperature. In some aspects, the heating source may be a gas burner, an electric heating element, a heat pump, and/or the like. Any heating source or combinations thereof may be used.

The PCM may be configured to extract heat from an external energy source or from the water stored in the storage tank when a water temperature in the storage tank is greater than a PCM temperature. Further, the PCM may be configured to transfer heat to the water stored in the storage tank when the water temperature is lower than the PCM temperature.

In certain embodiments, the storage tank may include a bottom head (e.g., a dome-shaped bottom head) in a bottom portion of the storage tank that may include an enclosure. The PCM may be stored in the enclosure formed in the bottom head of the storage tank. Further, in some instances, the enclosure may include a resistive heating element (or any other type of heating element) that may be connected to an external energy source, e.g., a renewable energy source. The external energy source may heat the PCM via the resistive heating element at a predefined frequency (e.g., every 1 hour, 2 hours, 3 hours, etc.). The PCM may transfer heat to the water stored in the storage tank via the bottom portion of the storage tank (e.g., via a top surface of the bottom head), when the water temperature in proximity to the bottom portion of the storage tank is lower than the PCM temperature. In this manner, the PCM may heat the water stored in the storage tank without requiring the primary heating source to heat the stored water frequently, thus saving energy resources and enhancing water heater efficiency.

In some embodiments, the PCM may be wrapped around the exterior surface of the storage tank in proximity to the bottom portion and/or a top portion of the storage tank. In other instances, the PCM may be wrapped around an interior surface of the storage tank in proximity to the bottom portion and/or a top portion of the storage tank. In some instances, the PCM may be in communication with an external energy source to heat the PCM during operation. In other instances, the PCM may not be in communication with the external energy source to heat the PCM during operation, and the PCM may instead extract heat from the water stored in the storage tank when the water temperature is greater than the PCM temperature. Further, the PCM may transfer heat to the stored water when the water temperature is lower than the PCM temperature. In some instances, since the PCM heats the water stored in the storage tank, the heating source may not be required to heat the water frequently, thus enhancing the water heater efficiency.

In certain embodiments, the PCM may be disposed in proximity to an outlet of the storage tank where hot water from the storage tank may flow out when a user draws hot water from the storage tank/water heater. In this case, the PCM may extract heat from the hot water dispensed from the storage tank when the water temperature is greater than the PCM temperature and may transfer heat back to the water when the water temperature is lower than the PCM temperature. By disposing the PCM in proximity to the outlet, a First Hour Rating (FHR) of the water heater may be enhanced. Specifically, since the PCM transfers heat to the water dispensed from the storage tank when the water temperature is lower than the PCM temperature, the water heater may be able to provide hot water for a longer time duration than a conventional water heater, thus achieving a higher FHR. As used herein, the FHR refers to the number of gallons of hot water the heater can supply per hour (starting with a tank full of hot water).

The present disclosure discloses a water heater with a storage tank and a PCM. Since the PCM transfers heat to the water stored in the storage tank, the heating source may be required to heat the stored water less frequently, thus enhancing the water heater efficiency. Further, when the PCM is disposed in proximity to the outlet of the storage tank, the water heater may provide hot water for longer time duration, thereby achieving higher FHR, as described above. The other advantages of the present disclosure are provided in detail herein.

Although certain examples of the disclosed technology are explained in detail herein, it is to be understood that other examples, embodiments, and implementations of the disclosed technology are contemplated. Accordingly, it is not intended that the disclosed technology is limited in its scope to the details of construction and arrangement of components expressly set forth in the following description or illustrated in the drawings. The disclosed technology can be implemented in a variety of examples and can be practiced or carried out in various ways. In particular, the presently disclosed subject matter is described in the context of being a system and method for heating water with a tank water heater having a Phase Change Material (PCM). The present disclosure, however, is not so limited, and can be applicable in other contexts. The present disclosure, for example and not limitation, can include other water heater systems, such as boilers, pool heaters, industrial water heaters, and other water heater systems configured to heat water or any combination thereof. Furthermore, the present disclosure can include other fluid heating systems configured to heat a fluid other than water such as process fluid heaters used in industrial applications. Such implementations and applications are contemplated within the present disclosure scope. Accordingly, when the present disclosure is described in the context of being a system and method for heating water with a tank water heater having a PCM, it will be understood that other implementations can take the place of those referred to.

Although the term “water” is used throughout this specification, it is to be understood that other fluids may take the place of the term “water” as used herein. Therefore, although described as a water heating system, it is to be understood that the system and method described herein can apply to fluids other than water. Further, it is also to be understood that the term “water” can replace the term “fluid” as used herein unless the context clearly dictates otherwise.

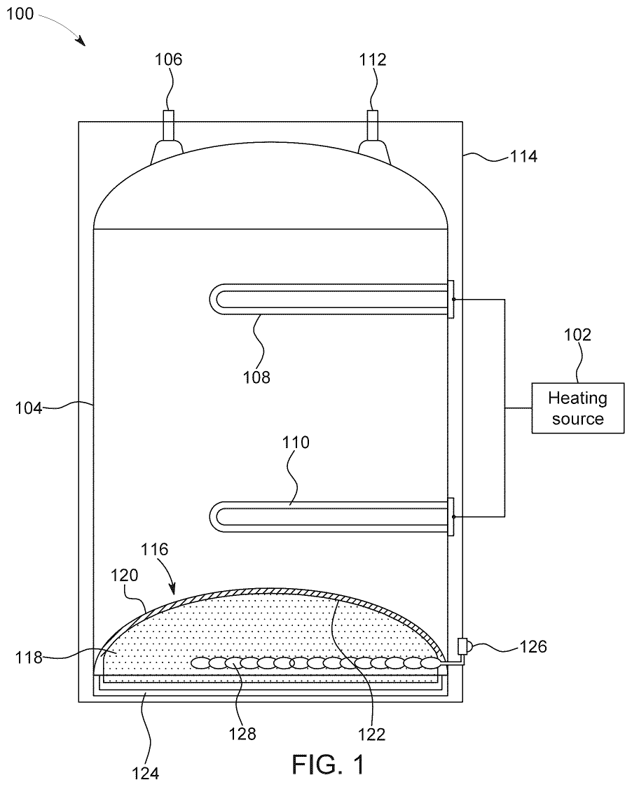

Turning now to the drawings, FIG. 1 depicts a water heater 100 in accordance with one or more embodiments of the present disclosure. The water heater 100 may include a heating source 102 and a water storage tank 104 (or storage tank 104). The heating source 102 may be a gas burner, an electrical heating element, a heat pump (e.g., a condenser coil thereof), a combination thereof, and/or the like.

The storage tank 104 may be configured to receive a supply of water (e.g., cold water) from an inlet 106 and store the received water. The heating source 102 may be configured to heat the water stored in the storage tank 104 to a predefined temperature (e.g., a first predefined temperature). In some aspects, the first predefined temperature may be a desired water temperature that may be pre-set by a water heater user. In an exemplary aspect, the first predefined temperature may be in a range of 120-130 degrees Fahrenheit.

In some aspects, the heating source 102 may heat the water stored in the storage tank 104 via one or more heating elements that may be disposed in an interior portion of the storage tank 104 or wrapped around an exterior surface of the storage tank 104. For example, the heating source 102 may heat the water stored in the storage tank 104 via a first heating element 108 (e.g., an “upper” heating element) that may be disposed in the storage tank 104 in proximity to a top portion of the storage tank 104, and a second heating element 110 (e.g., a “lower” heating element) that may be disposed in proximity to a bottom portion of the storage tank 104. The arrangement of the first and second heating elements 108, 110 depicted in FIG. 1 is exemplary in nature and should not be construed as limiting. Further, in some aspects, the water heater 100 may include more or less than two heating elements depicted in FIG. 1. In an exemplary aspect, the first and second heating elements 108, 110 may be heat exchangers configured to transfer heat from the heating source 102 to the water stored in the storage tank 104.

The water heater 100 may further include one or more thermostats (not shown) that may be configured to detect water temperature at different locations in the interior portion of the storage tank 104, and activate the heating source 102 to heat the water stored in the storage tank 104 when the detected water temperature drops below a predetermined activation temperature. For example, a thermostat disposed in proximity to the second heating element 110 may activate the heating source 102 when the water temperature in proximity to the bottom portion of the storage tank 104 drops below 110 degrees Fahrenheit. In some aspects, the water temperature may drop in the storage tank 104 when the user draws hot water from the storage tank 104 or when the water stored in the storage tank 104 gradually dissipates heat to ambient environment (e.g., as standby heat loss).

Responsive to heating source activation, the heating source 102 may heat the water stored in the storage tank 104 to the first predefined temperature (e.g., the desired water temperature). The storage tank 104 may be configured to output hot water at the desired water temperature from an outlet 112 when the user draws hot water from the water heater 100.

The storage tank 104 may be of any size, shape, or configuration based on the water heater application. For example, the storage tank 104 may be sized for common residential use or for commercial or industrial use that may require greater amounts of heated water. Furthermore, the storage tank 104 can be made of any suitable material for storing and heating water, including copper, carbon steel, stainless steel, ceramics, polymers, composites, or any other suitable material. The storage tank 104 may also be treated or lined with a coating to prevent corrosion and leakage. A suitable treating or coating will be capable of withstanding the temperature and pressure of the water heater 100 and can include, as non-limiting examples, glass enameling, galvanizing, thermosetting resin-bonded lining materials, thermoplastic coating materials, cement coating, or any other suitable treating or coating for the application. Optionally, the storage tank 104 may be insulated to retain heat. For example, the storage tank 104 may be insulated using an insulation foam 114 that may enclose the storage tank 104, or by using fiberglass, aluminum foil, organic material, or any other suitable insulation material.

In some aspects, the bottom portion of the storage tank 104 may include a dome-shaped bottom head 116 (or a bottom head of any other shape) forming an enclosure 118 at the bottom portion of the storage tank 104. An interior surface 120 of the bottom head 116 may be in contact with water stored in the storage tank 104, and an exterior surface 122 of the bottom head 116 may define the enclosure 118. In some aspects, the exterior surface 122 may be coated with a thermal interface enhancement material, such as silver, copper, aluminum, silicon carbide, etc. In further aspects, the base of the storage tank 104 may include a tank support structure or a base plate 124 that may “close” the enclosure 118 from the bottom side of the storage tank 104. In this manner, the enclosure 118 may be secured from ambient environment by the exterior surface 122 of the bottom head 116 on a top side of the enclosure 118 and the base plate 124 on the bottom side of the enclosure 118.

The enclosure 118 may be configured to hold/store a Phase Change Material (PCM). The PCM may be organic, inorganic or eutectic. An energy source 126 may heat the PCM to a second predefined temperature at a predefined frequency (e.g., every 1 hour, 2 hours, etc.). In some aspects, the energy source 126 may be the same energy source (e.g., a utility power supply) that may power the water heater 100, or may be a renewable energy source, e.g., a solar photovoltaic energy unit, a wind energy unit, etc. Using a renewable energy source ensures that water heater efficiency is not affected by activating the energy source 126 to heat the PCM. In some aspects, the energy source 126 may be disposed in proximity to the water heater 100 or the storage tank 104 (as shown in FIG. 1). In other aspects, the energy source 126 may be disposed away from the water heater 100 or the storage tank 104. The energy source 126 may heat the PCM by using a heating element 128 that may be disposed inside the enclosure 118. Specifically, the energy source 126 may energize the heating element 128 at the predefined frequency to heat the PCM to the second predefined temperature. In an exemplary aspect, the heating element 128 may be a resistance heater.

In some aspects, the second predefined temperature may be equivalent to or greater than a melting point of the PCM. In further aspects, the melting point of the PCM may be between the first predefined temperature (e.g., the desired water temperature) and a typical or an average historical temperature of the bottom portion of the storage tank 104. For example, the melting point may be an average of the desired water temperature (e.g., 125 degrees Fahrenheit) and a typical temperature of the bottom head 116 (e.g., in a range of 108-112 degrees Fahrenheit) during water heater operation or standby phase, which a manufacturer of the water heater 100 may measure/determine.

In an exemplary aspect, if a typical desired water temperature from the water heater 100 is 125 degrees Fahrenheit and a typical bottom portion temperature is 112 degrees Fahrenheit, the melting point of the PCM may be in range of 115 to 119 degrees Fahrenheit. In this case, the water heater manufacturer may choose that PCM for the water heater 100 that may have a melting point close to 115 degrees Fahrenheit.

In operation, the energy source 126 may energize the heating element 128 to heat the PCM to the second predefined temperature (e.g., 115 or more degrees Fahrenheit). In some aspects, an amount of energy transferred by the energy source 126 to the PCM may be equivalent to a typical standby heat loss of the PCM. Responsive to being heated to the second predefined temperature, the PCM may melt. Further, when the temperature of the water stored in the storage tank 104 in proximity to the tank bottom portion drops below the PCM temperature (e.g., the second predefined temperature), the PCM may transfer heat to the water via the exterior surface 122 of the bottom head 116 (that includes the thermal interface enhancement material, as described above) and gradually solidify. In this manner, the water stored in the storage tank 104 may obtain heat from the PCM, and thus a rate of drop of water temperature in the storage tank 104 may decrease responsive to the water obtaining heat from the PCM.

Since the rate of drop of water temperature in the storage tank 104 decreases by using the PCM, the thermostats located in the storage tank 104 activate the heating source 102 less frequently (as the water temperature drops below the predetermined activation temperature more slowly or with a delay), thus enhancing the water heater efficiency. Further, since the PCM is stored within the existing hardware of the storage tank 104 (i.e., within the dome-shaped bottom head 116), no extra storage space is required to store the PCM, thus enabling ease of manufacturing and use of the storage tank 104/water heater 100.

The water heater 100 may include additional sensors or components, which may enable efficient water heater operation. Examples of such additional sensors or components include, but are not limited to, a pressure sensor, a scale, a voltmeter, an ammeter, a power meter, an ohmmeter, an electric power meter, a resistance temperature detector, and/or the like. These additional sensors or components are not shown in FIG. 1 for the sake of simplicity and conciseness.

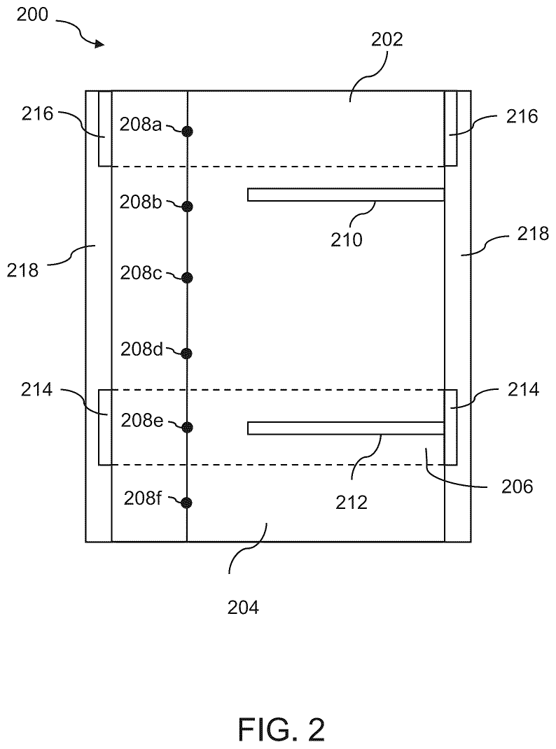

FIG. 2 depicts a cross-sectional view of a storage tank 200 of a water heater (e.g., the water heater 100) in accordance with one or more embodiments of the present disclosure. The storage tank 200 may be similar to the storage tank 104 described above in conjunction with FIG. 1; however, the storage tank 200 may not store the PCM in a bottom portion or bottom head of the storage tank 200. For the sake of simplicity and conciseness, the heating source 102 is not depicted in FIG. 2.

In an exemplary aspect, the storage tank 200 may include a plurality of zones in an interior portion of the storage tank 200 in which water may be stored. For example, as shown in FIG. 2, the storage tank 200 may include a top portion or top zone 202, a lower bottom portion or lower bottom zone 204, an upper bottom portion or upper bottom zone 206, and one or more middle portions or middle zones (not shown) disposed between the top zone 202 and the upper bottom zone 206. In an exemplary aspect, the storage tank 200 may include six zones, and each zone may include or have an associated thermocouple or thermistor 208a, 208b, 208c, 208d, 208e and 208f. Each thermocouple may be configured to measure temperature of water in the respective zone. For example, the thermocouple 208a may measure water temperature in the top zone 202, the thermocouple 208e may measure water temperature in the upper bottom zone 206, and/or the like.

One or more thermocouples may have associated thermostats (not shown) that may activate the heating source 102 when the water temperature in the associated zone drops below the predefined activation temperature. For example, a thermostat associated with the thermocouple 208e may activate the heating source 102 when the water temperature in the upper bottom zone 206 drops below the predefined activation temperature, e.g., 110 degrees Fahrenheit. Responsive to being activated, the heating source 102 may heat water stored in the storage tank 200 via a first heating element 210 (e.g., an “upper” heating element) and a second heating element 212 (e.g., a “lower” heating element), as described above in conjunction with FIG. 1. The first heating element 210 may be same as the first heating element 108, and the second heating element 212 may be same as the second heating element 110. In the exemplary aspect depicted in FIG. 2, the first heating element 210 is disposed in proximity to the top zone 202 and the second heating element 212 is disposed in the upper bottom zone 206. The present disclosure is not limited to the arrangement of the first and second heating elements 210, 212 depicted in FIG. 2, and the storage tank 200 may have the first and second heating elements 210, 212 disposed at other locations in the storage tank 200 without departing from the present disclosure scope. Further, the storage tank 200 may include less or more than two heating elements.

In some aspects, a first PCM patch 214 may be wrapped around an exterior surface of the storage tank 200 in proximity to the bottom portion of the storage tank 200. For example, as depicted in FIG. 2, the first PCM patch 214 may be wrapped around the exterior surface of the upper bottom zone 206. In an exemplary aspect, the first PCM patch 214 may have a width in a range of 3 to 5 inches, and a thickness in a range of 0.2 to 0.5 inches. The first PCM patch 214 (or the first PCM 214) may be configured to extract heat from the water stored in the storage tank 104 and melt, when the water temperature in the upper bottom zone 206 may be greater than a melting point (e.g., a first melting point) of the first PCM 214. For example, if the water temperature in the upper bottom zone 206 is 120 degrees Fahrenheit and the first melting point is 115 degrees Fahrenheit, the first PCM 214 may extract heat from the water and melt. Further, the first PCM 214 may transfer heat back to the water stored in the storage tank 104 and gradually solidify, when the water temperature in the upper bottom zone 206 drops below the first melting point. As described above in conjunction with FIG. 1, the water temperature in the upper bottom zone 206 may drop when the user draws hot water from the storage tank 200 or when the storage tank 200 gradually dissipates heat during standby phase.

Since the first PCM 214 transfers heat back to the water stored in the storage tank 104 when the water temperature drops, the rate of drop of water temperature in the storage tank 200 may decrease, thereby ensuring that the heating source 102 may not be frequently activated, as described above in conjunction with FIG. 1. Reduced frequency of heating source activation may enhance the water heater efficiency and conserve energy resources.

In some aspects, the first PCM 214 may be additionally (or initially, when the water heater may be operated for a first time or after a substantial time duration) activated by an energy source (not shown) that may heat the first PCM 214 to the first melting point. Responsive to being heated by the energy source for the first time, the first PCM 214 may extract/transfer heat from/to the water stored in the storage tank 200, as described above.

In additional aspects, a second PCM patch 216 may be wrapped around the exterior surface of the storage tank 200 in proximity to the top portion of the storage tank 200. For example, the second PCM patch 216 may wrapped around the exterior surface of the top zone 202, as depicted in FIG. 2. Dimensions of the second PCM patch 216 (or the second PCM 216) may be same as dimensions of the first PCM patch 214. The second PCM 216 may have an associated second melting point.

The function of the second PCM 216 may be similar to the function of the first PCM 214. For example, the second PCM 216 may extract heat from the water stored in the storage tank 200 and melt, when the water temperature in the top zone 202 may be greater than the second melting point. Further, the second PCM 216 may transfer heat to the water stored in the storage tank 200 and gradually solidify, when the water temperature in the top zone 202 drops below the second melting point.

Since the water temperature in the top zone 202 is typically greater than the water temperature in the upper bottom zone 206, the second melting point may be greater than the first melting point. Specifically, the water heater manufacturer may choose PCMs to install in the storage tank 200 such that the melting point of the second PCM 216 may be greater than the melting point of the first PCM 214, to ensure effective functioning of respective PCMs and enhancement of the water heater efficiency.

Although FIG. 2 depicts two PCM patches, the storage tank 200 may have additional PCM patches disposed at different locations inside or outside the storage tank 200, to enable enhancement of the water heater efficiency. For example, another PCM patch (e.g., a third PCM, not shown) may be wrapped around or disposed in proximity to a thermostat (e.g., between the thermostat and a fiber mat of the storage tank 200) that may ensure that the temperature in proximity to the thermostat does not drop rapidly, thereby preventing the thermostat from activating the heating source 102 frequently.

In further aspects, the storage tank 200 may include additional components that may ensure efficient water heater operation. For example, an insulation foam 218 may wrap an exterior surface of the storage tank 200 (and the first and second PCMs 214, 216) that may ensure that latent heat is not dissipated (or minimally dissipated) to ambient environment. Further storage tank components, e.g., inlet, outlet, etc., are not shown in FIG. 2 for the sake of simplicity.

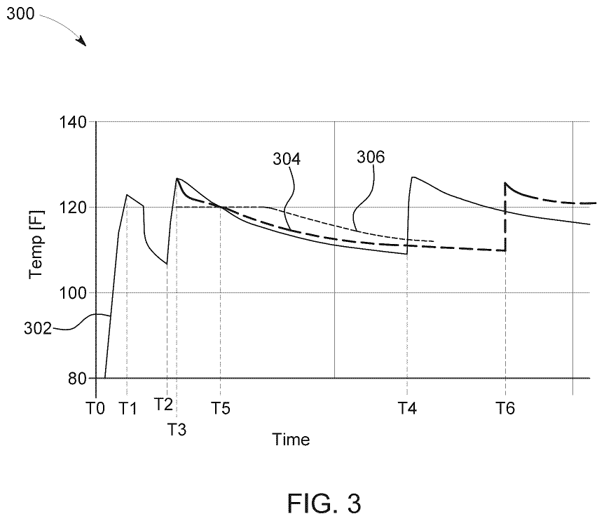

FIG. 3 depicts a graph 300 illustrating a change of temperature with time in the storage tank 200 in accordance with one or more embodiments of the present disclosure. Specifically, the graph 300 illustrates a change of temperature with time in the upper bottom zone 206 (around which the first PCM 214 may be wrapped, as described above).

Y-axis of the graph 300 depicts temperature in degrees Fahrenheit, and X-axis depicts time (e.g., in hours). A first temperature line 302 depicts temperature in the upper bottom zone 206 when the first PCM 214 may not be wrapped around the upper bottom zone 206. A second temperature line 304 depicts temperature in the upper bottom zone 206 when the first PCM 214 may be wrapped around the upper bottom zone 206. A third temperature line 306 depicts temperature of the first PCM 214.

From time T=0 to T=T1, the heating source 102 may heat the water stored in the storage tank 200 to a desired water temperature (e.g., 125 degrees Fahrenheit), and then stop heating the water when the desired water temperature may be reached. The water temperature in the upper bottom zone 206 may then drop substantially when hot water may be drawn from the storage tank 200 by the user, as shown by the drop in temperature in the first temperature line 302 between time T=T1 to T=T2. When the temperature in the upper bottom zone 206 drops below the predetermined activation temperature (e.g., 110 degrees Fahrenheit), the thermostat of the upper bottom zone 206 may cause activation of the heating source 102, which may result in heating of the water to the desired water temperature between time T=T2 and T=T3, as shown in FIG. 3.

In an exemplary aspect, the water heater may then enter a standby phase at time T=T3. Stated another way, the user may not draw hot water from the storage tank 200 after time T=T3. In such a scenario, the storage tank 200 (and the water stored in the storage tank 200) may begin to gradually dissipate heat to ambient environment.

When the first PCM 214 may not be wrapped around the upper bottom zone 206, the storage tank 200/water may continue to dissipate heat between time T=T3 till T=T4, as shown by the first temperature line 302. At time T=T4, the water temperature may drop below the predetermined activation temperature (e.g., 110 degrees Fahrenheit). At this point, the thermostat may cause activation of the heating source 102, which may heat the water to the desired water temperature, as described above.

On the other hand, when the first PCM 214 may be wrapped around the upper bottom zone 206, the first PCM 214 may transfer heat to the water stored in the storage tank 200 when the water temperature drops below the first PCM temperature, as shown at time T=T5. The first PCM 214 may gradually transfer heat to the water stored in the storage tank 200 from T=T5, which results in drop of the first PCM temperature, as shown by the third temperature line 306. Further, since the water receives heat from the first PCM 214, the water temperature drops with a reduced rate as compared to the rate of temperature drop when the first PCM 214 may not be wrapped around the upper bottom zone 206, as shown in the second temperature line 304.

Since the rate of temperature drop may be reduced when the first PCM 214 may be wrapped around the upper bottom zone 206, the water temperature may take more time to drop to the level of the predetermined activation temperature (e.g., 110 degrees Fahrenheit). For example, as shown by the second temperature line 304, the water temperature drops to the predetermined activation temperature at time T=T6 (when the first PCM 214 may be wrapped around the upper bottom zone 206), which is delayed from the time T=T4. Since there is a delay in the water temperature reaching to the level of the predetermined activation temperature, there is a delay in activating the heating source 102 by the thermostat, thus ensuring less frequent heating source activation. In this manner, the water heater efficiency may be enhanced by wrapping the first PCM 214 around the exterior surface of the storage tank 200 (e.g., around the upper bottom zone 206).

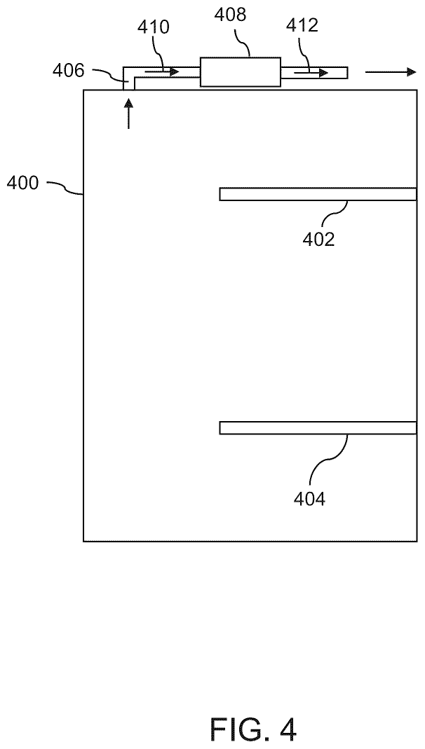

FIG. 4 depicts a cross-sectional view of a storage tank 400 in accordance with one or more embodiments of the present disclosure. The storage tank 400 may be same as the storage tank 200 described above in conjunction with FIG. 2. The storage tank 400 may include a first heating element 402 (same as the first heating element 210), a second heating element 404 (same as the second heating element 212), an outlet 406, and other components/units including an inlet, one or more thermocouples, insulation foam, etc. described above in conjunction with FIGS. 1 and 2. For the sake of simplicity, the other components/units of the storage tank 400 are not depicted in FIG. 4.

As described above, the storage tank 400 may be configured to store water received via the inlet, and the heating source 102 may heat the water via the first and second heating elements 402, 404 to a predefined temperature (e.g., a first predefined temperature that may be equivalent to a desired water temperature). The storage tank 400 may dispense hot water 410 at the first predefined temperature (e.g., 125 degrees Fahrenheit) via the outlet 406 when the user draws hot water from the storage tank 400/water heater.

In some aspects, a PCM patch 408 (or a PCM 408) may be a part of the water heater including the storage tank 400, and may be configured to receive the hot water 410 at the first predefined temperature from the outlet 406 when the user draws water from the storage tank 400. The PCM 408 may extract heat from the hot water 410 and melt, when the first predefined temperature (e.g., 125 degrees Fahrenheit) may be greater than a melting point (e.g., 120 degrees Fahrenheit) of the PCM 408. Responsive to extracting heat from the hot water, the PCM 408 may output hot water 412 at a second predefined temperature, which may be slightly less than the first predefined temperature. For example, the second predefined temperature may be 123 degrees Fahrenheit if the first predefined temperature is 125 degrees Fahrenheit.

On the other hand, the PCM 408 may transfer heat to the water output from the outlet 406 and gradually solidify, when the temperature of water output from the outlet 406 may be less than the PCM temperature or the melting point of the PCM 408. For example, the PCM 408 may transfer heat to the water output from the outlet 406 when the hot water stored in the storage tank 400 may be depleting and water temperature may be dropping, thus enabling the water output from the water heater to remain hot for a longer time duration as compared to a conventional water heater. In this manner, the PCM 408 acts as a heat “booster”, and the water heater with the storage tank 400 and the PCM 408 may enhance water heater First Hour Rating (FHR).

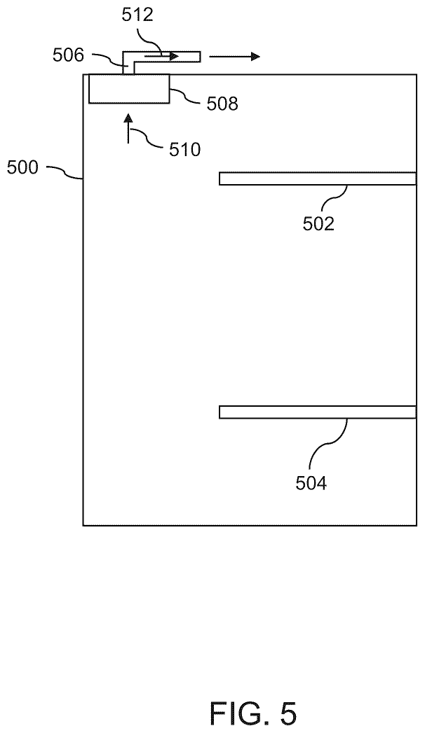

The arrangement/location of the PCM 408 in the water heater as shown in FIG. 4 is for illustrative purpose and should not be construed as limiting. The PCM 408 may be located in other locations, e.g., inside the storage tank 400, without departing from the present disclosure scope, as described below in conjunction with FIG. 5.

FIG. 5 depicts a cross-sectional view of a storage tank 500 in accordance with one or more embodiments of the present disclosure. The storage tank 500 may be same as the storage tank 400, and may include a first heating element 502 (same as the first heating element 402), a second heating element 504 (same as the second heating element 404), an outlet 506, an inlet (not shown), one or more thermocouples (not shown), and other components/units described above in conjunction with FIGS. 1, 2 and 4.

As shown in FIG. 5, a PCM patch 508 (or a PCM 508) may be disposed inside the storage tank 500 in proximity to the outlet 506, as opposed to outside the storage tank as depicted in FIG. 4. In this case, the PCM 508 may directly receive hot water 510 at the first predefined temperature from the storage tank 500, when the user draws water from the water heater/storage tank 500. The PCM 508 may extract heat from the hot water 510 when the first predefined temperature may be more than the PCM temperature, and may output hot water 512 to the outlet 506 at the second predefined temperature, as described above.

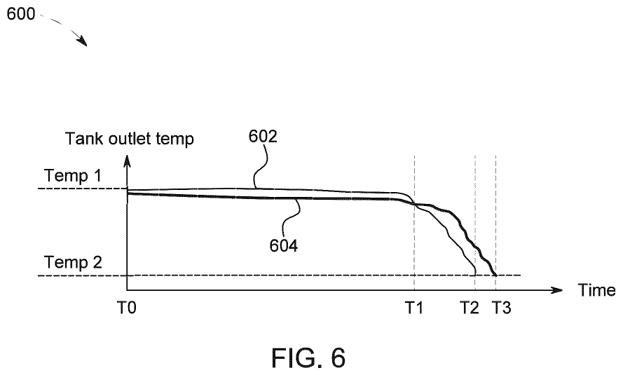

On the other hand, the PCM 508 may transfer heat to the water when the water temperature in the storage tank 500 may be less than the PCM temperature, as described above in conjunction with FIG. 4. The effect of the PCM 508 on the temperature of water dispensed from the outlet 506 is described below in conjunction with FIG. 6.

FIG. 6 depicts an example graph 600 illustrating a change in tank outlet temperature with time in accordance with one or more embodiments of the present disclosure. Specifically, the graph 600 depicts a change in temperature of water output from the outlet 506 with time.

Y-axis of the graph 600 depicts temperature in degrees Fahrenheit, and X-axis depicts time (e.g., in minutes). A first temperature line 602 depicts temperature of water dispensed from the outlet 506 when the PCM 508 may not be installed or disposed in the storage tank 500 in proximity to the outlet 506. A second temperature line 604 depicts temperature of water dispensed from the outlet 506 when the PCM 508 may be installed or disposed in the storage tank 500 in proximity to the outlet 506, as described above in conjunction with FIG. 5.

As shown by the first temperature line 602, when the user draws hot water from the storage tank 500, temperature “Temp 1” of hot water dispensed from the outlet 506 may remain steady or constant from time T=0 till time T=T1. At time T=T1, the hot water stored in the storage tank 500 may get depleted and get replenished with cold water, resulting in quick drop of water temperature, as shown by the first temperature line 602. For example, the temperature “Temp 1” may quickly drop to a temperature “Temp 2” (which may be 15 to 20 degrees Fahrenheit lower than “Temp 1”) between time T=T1 and T=T2.

On the other hand, when the PCM 508 may be installed or disposed in the storage tank 500 in proximity to the outlet 506, the rate of drop of water temperature may be slower as the PCM 508 may transfer heat to the water dispensed from the outlet 506. For example, as shown by the second temperature line 604, the water temperature may drop from “Temp 1” to “Temp 2” between time T=T1 and T=T3, in which T3 may be greater than T2. Therefore, the rate of water temperature drop may be reduced, resulting in dispensing of hot water for a longer time duration from the outlet 506. In this manner, the PCM 508 enhances the water heater FHR when the PCM 508 may be disposed in the storage tank 500 in proximity to the outlet 506.

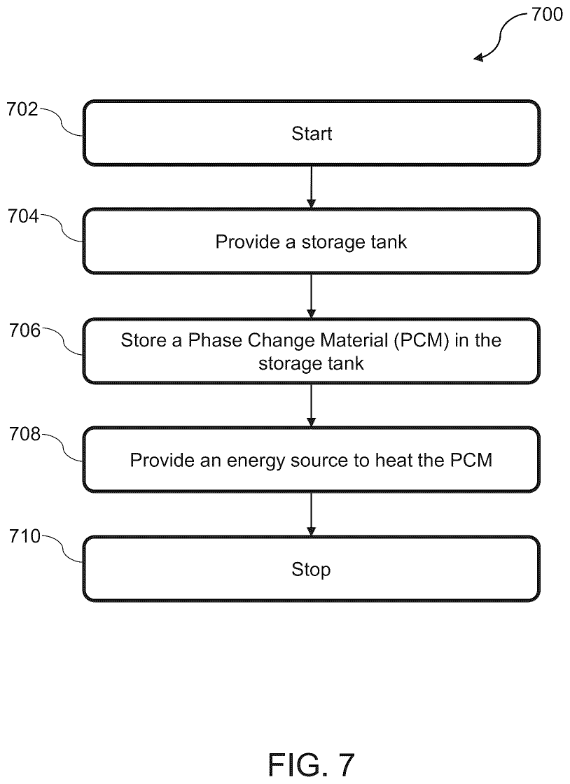

FIG. 7 depicts a flow diagram of a method 700 to provide a water heater with a PCM in accordance with one or more embodiments of the present disclosure. FIG. 7 may be described with continued reference to prior figures, including FIGS. 1-6. The following process is exemplary and not confined to the steps described hereafter. Moreover, alternative embodiments may include more or less steps than are shown or described herein and may include these steps in a different order than the order described in the following example embodiments.

The method 700 starts at step 702. At step 704, the method 700 may include providing the storage tank 104 with the bottom head 116, as described above in conjunction with FIG. 1. At step 706, the method 700 may include storing the PCM in the enclosure 118 of the bottom head 116. At step 708, the method 700 may include heating the PCM by using the energy source 126 and the heating element 128. As described above in conjunction with FIG. 1, responsive to getting heated, the PCM may transfer heat to the water stored in the storage tank 104, when the water temperature may be lower than the PCM temperature.

The method 700 ends at step 710.

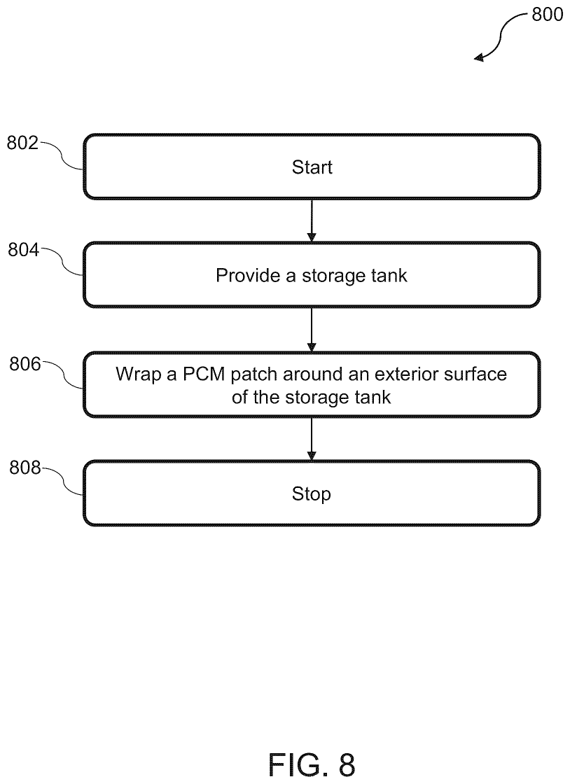

FIG. 8 depicts a flow diagram of a method 800 to provide a water heater with a PCM in accordance with one or more embodiments of the present disclosure. FIG. 8 may be described with continued reference to prior figures, including FIGS. 1-7. The following process is exemplary and not confined to the steps described hereafter. Moreover, alternative embodiments may include more or less steps than are shown or described herein and may include these steps in a different order than the order described in the following example embodiments.

The method 800 starts at step 802. At step 804, the method 800 may include proving the storage tank 200 with the plurality of zones in the interior portion of the storage tank 200, as described above in conjunction with FIG. 2. At step 806, the method 800 may include wrapping the first PCM patch 214 around the exterior surface of the upper bottom zone 206. As described above, the first PCM 214 may extract heat from the water stored in the storage tank 104 when the water temperature in the upper bottom zone 206 may be greater than the PCM temperature, and may transfer heat to the water when the water temperature may be lower than the PCM temperature.

The method 800 ends at step 808.

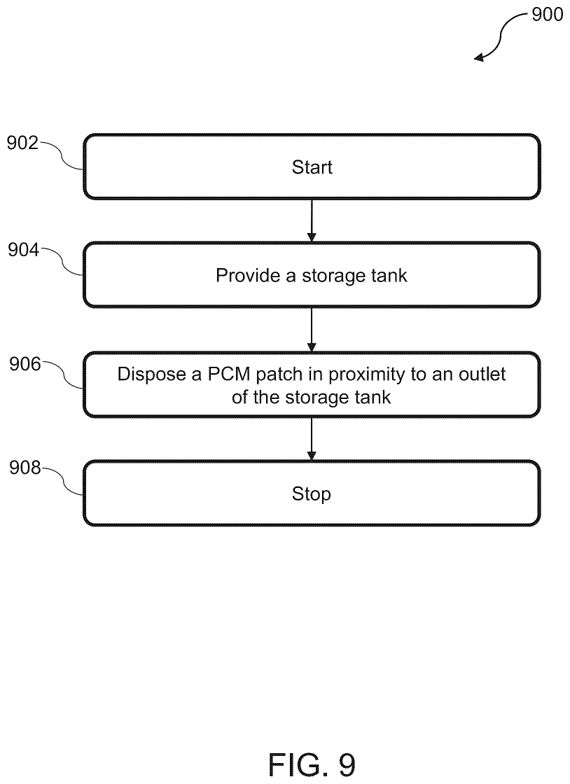

FIG. 9 depicts a flow diagram of a method 900 to provide a water heater with a PCM in accordance with one or more embodiments of the present disclosure. FIG. 9 may be described with continued reference to prior figures, including FIGS. 1-8. The following process is exemplary and not confined to the steps described hereafter. Moreover, alternative embodiments may include more or less steps than are shown or described herein and may include these steps in a different order than the order described in the following example embodiments.

The method 900 starts at step 902. At step 904, the method 900 may include proving the storage tank 400 or 500. At step 906, the method 900 may include disposing the PCM patch 408 or 508 in proximity to the outlet 406 or 506, as described above in conjunction with FIGS. 4 and 5. The PCM patch 408, 508 may extract heat from the water dispensed from the storage tank 400, 500 when the water temperature may be greater than the PCM temperature, and may transfer heat back to the water when the water temperature may be lower than the PCM temperature, as described above.

The method 900 ends at step 908.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc., should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A water heater comprising:
a storage tank configured to store water, wherein the storage tank comprises a top portion and a bottom portion, and wherein the bottom portion comprises an enclosure with a phase changing material (PCM); and
an energy source or the water stored in the storage tank is configured to heat the PCM to a first predefined temperature, wherein the PCM is configured to transfer heat to the water stored in the storage tank when a temperature of water stored in the storage tank drops below the first predefined temperature.

2. The water heater of claim 1, wherein the first predefined temperature is equivalent to a melting point of the PCM.

3. The water heater of claim 1 further comprising a heating source configured to heat water stored in the storage tank to a second predefined temperature.

4. The water heater of claim 3, wherein the first predefined temperature is between the second predefined temperature and an average historical temperature of the bottom portion.

5. The water heater of claim 4, wherein the first predefined temperature is an average of the second predefined temperature and the average historical temperature of the bottom portion.

6. The water heater of claim 1 further comprising a heating source disposed in the enclosure, wherein the energy source is configured to energize the heating source at a predefined frequency to heat the PCM.

7. The water heater of claim 6, wherein the heating source comprises a resistance heater.

8. The water heater of claim 1, wherein the energy source comprises a renewable energy source.

9. A water heater, comprising:
a storage tank configured to store water, wherein the storage tank comprises a top portion and a bottom portion; and
a first phase changing material (PCM) disposed about the storage tank in proximity to the bottom portion,
wherein the first PCM is configured to extract heat from water in the storage tank and melt when a temperature of water in the storage tank in proximity to the bottom portion is greater than a first melting point of the first PCM, and
wherein the first PCM is configured to transfer heat to the water in the storage tank and solidify when the temperature of water in the storage tank in proximity to the bottom portion is less than the first melting point.

10. The water heater of claim 9 further comprising a second PCM disposed about the storage tank in proximity to the top portion, wherein the second PCM has a second melting point.

11. The water heater of claim 10, wherein the second PCM is configured to extract heat from water in the storage tank and melt, when the temperature of water in the storage tank in proximity to the top portion is greater than the second melting point, and wherein the second PCM is configured to transfer heat to the water in the storage tank and solidify, when the temperature of water in the storage tank in proximity to the top portion is less than the second melting point.

12. The water heater of claim 10, wherein the second melting point is greater than the first melting point.

13. The water heater of claim 9 further comprising an energy source configured to heat the first PCM to the first melting point.

14. The water heater of claim 9 further comprising a thermostat configured to measure water temperature inside the storage tank.

15. The water heater of claim 14 further comprising a third PCM disposed over the thermostat.

16. A water heater comprising:
a storage tank configured to store water and dispense hot water at a first predefined temperature; and
a phase changing material (PCM) configured to receive hot water at the first predefined temperature from the storage tank, wherein the PCM is configured to:
extract heat from the hot water and melt when the first predefined temperature is greater than a melting point of the PCM, and
transfer heat to the hot water when the first predefined temperature is less than the melting point.

17. The water heater of claim 16, wherein the PCM is configured to transfer heat with the hot water to output the hot water at a second predefined temperature.

18. The water heater of claim 17 further comprising an outlet disposed on the storage tank.

19. The water heater of claim 18, wherein the PCM is disposed about the outlet, and wherein the PCM is configured to receive hot water at the first predefined temperature from the storage tank via the outlet.

20. The water heater of claim 18, wherein the PCM is disposed about the outlet, wherein the PCM is configured to transfer heat with the hot water to output the hot water at the second predefined temperature to the outlet.
